(19) United States
(12) Patent Application Publication
(10) Pub. No.: US 2026/0297969 A1
(43) Pub. Date: Oct. 1, 2026

(54) DEBRIS REMOVAL SLEEVE

(71) Applicant: Ron Cleveland, Mesa, AZ (US)

(72) Inventor: Ron Cleveland, Mesa, AZ (US)

(21) Appl. No.: 19/097,038

(22) Filed: Apr. 1, 2025

(51) Int. Cl. E04H 4/12; B01D 17/02; C02F 1/28; C02F 1/40; C02F 1/68; C02F 101/32; C02F 103/42

(52) U.S. Cl. CPC E04H 4/1263; B01D 17/0202; C02F 1/285; C02F 1/40; C02F 1/685; E04H 4/1281; C02F 2101/32; C02F 2103/42

(57) ABSTRACT

A debris removal sleeve. The debris removal sleeve is configured to be attached to a floating chlorine/bromine dispenser. As the chlorine/bromine dispenser fitted with the sleeve floats and moves about the pool or spa, the sleeve absorbs oil, chemicals, and other debris that are floating on the top of the water and wipes debris from the coping as the sleeve bumps against it.

### TECHNICAL FIELD

This disclosure relates generally to pool and spa maintenance. More specifically, the present invention is a debris removal sleeve for pools and spas.

### BACKGROUND OF THE INVENTION

Many people have hair products, sun tan oil, sunscreen, lotion, or other products on their hair and skin when they are swimming or soaking in swimming pools or spas. These products are typically made with oils and other hydrophobic ingredients or chemicals. Debris from those hydrophobic ingredients and chemicals are washed off of the user's hair and skin while the person is in the water. With multiple people using the pools and spas, the hydrophobic debris accumulates and ultimately can form an oily layer or film on the water's surface. This hydrophobic debris may also stick to the coping surrounding the pool or spa.

Currently, the oily layer is removed from the pool by using a pool skimmer to collect the surface oil and by brushing the coping and sides of the pool or spa. This process may prove to be cumbersome and time consuming. The oily layer also remains on the water surface and on the coping in between cleanings, which looks unsightly.

The present disclosure provides for a debris removal sleeve that absorbs oils and other greasy residue floating on the surface of swimming pool and spa water. The debris removal sleeve also wipes oil and residue that may be stuck to the coping. The debris removal sleeve is configured to be attached to a floating chlorine dispenser. As the chlorine dispenser fitted with the sleeve floats and moves about the pool or spa, the sleeve absorbs debris that is floating on the top of the water and wipes debris from the coping as the sleeve bumps against it. Other benefits and advantages will become clear from the disclosure provided herein and those advantages provided are for illustration. The statements in this section merely provide the background related to the present disclosure and do not constitute prior art.

### SUMMARY OF THE INVENTION

This summary is provided to introduce a selection of concepts in a simplified form that are further described below in the DESCRIPTION OF THE DISCLOSURE. This summary is not intended to identify key features of the claimed subject matter, nor is it intended to be used as an aid in determining the scope of the claimed subject matter.

In accordance with one or more embodiments of the present invention, a debris removal sleeve is disclosed. The debris removal sleeve comprises: a circular flange; a cylindrical collar positioned perpendicularly to the circular flange; a center aperture passing through the debris removal sleeve; and an inner support ring for securing a chlorine dispenser within the debris removal sleeve.

In accordance with one or more embodiments of the present invention, a debris removal sleeve is disclosed. The debris removal sleeve comprises: a circular flange; a cylindrical collar positioned perpendicularly to the circular flange; a center aperture passing through the debris removal sleeve, the center aperture being defined by an inner side wall of the circular flange and an inner sidewall of the cylindrical collar; and an inner support ring for securing a chlorine dispenser within the debris removal sleeve, wherein the debris removal sleeve is constructed of a buoyant oil-absorbing foam material.

In accordance with one or more embodiments of the present invention, a debris removal sleeve is disclosed. The debris removal sleeve comprises: a circular flange; a cylindrical collar being integral with and extending upwardly and perpendicularly from the circular flange; a center aperture passing through the debris removal sleeve, the center aperture being defined by an inner side wall of the circular flange and an inner sidewall of the cylindrical collar; and an inner support ring for securing a chlorine dispenser within the debris removal sleeve, wherein the debris removal sleeve is constructed of one of reticulated polyester foam and reticulated polyurethane foam.

### BRIEF DESCRIPTION OF THE DRAWINGS

The novel features believed to be characteristic of the disclosure are set forth in the appended claims. The disclosure itself, as well as a preferred mode of use, further objectives and advantages thereof, will be best understood by reference to the following detailed description of illustrative embodiments when read in conjunction with the accompanying drawings, wherein:

FIG. 1 is a perspective view of an embodiment of a debris removal sleeve and one type of pool/spa chlorine dispenser;

FIG. 2 is a top view of the debris removal sleeve of FIG. 1;

FIG. 3 is a side view of the debris removal sleeve of FIG. 1;

FIG. 4 is a top perspective view of the debris removal sleeve of FIG. 1;

FIG. 5 is a top perspective view of the debris removal sleeve and the pool/spa chlorine dispenser of FIG. 1, shown coupled together;

FIG. 6 is a bottom perspective view of the debris removal sleeve and the pool/spa chlorine dispenser of FIG. 1, shown coupled together;

FIG. 7 is a is a top perspective view of another embodiment of the debris removal sleeve and another type of pool/spa chlorine dispenser; and

FIG. 8 top perspective view of the debris removal sleeve and the pool/spa chlorine dispenser of FIG. 7, shown coupled together.

### DETAILED DESCRIPTION OF THE INVENTION

The description set forth below in connection with the appended drawings is intended as a description of exemplary embodiments of the disclosure and is not intended to represent the only forms in which the present disclosure may be constructed and/or utilized. The description sets forth the functions and the sequence of blocks for constructing and operating the disclosure in connection with the illustrated embodiments. It is to be understood, however, that the same or equivalent functions and sequences may be accomplished by different embodiments that are also intended to be encompassed within the spirit and scope of this disclosure.

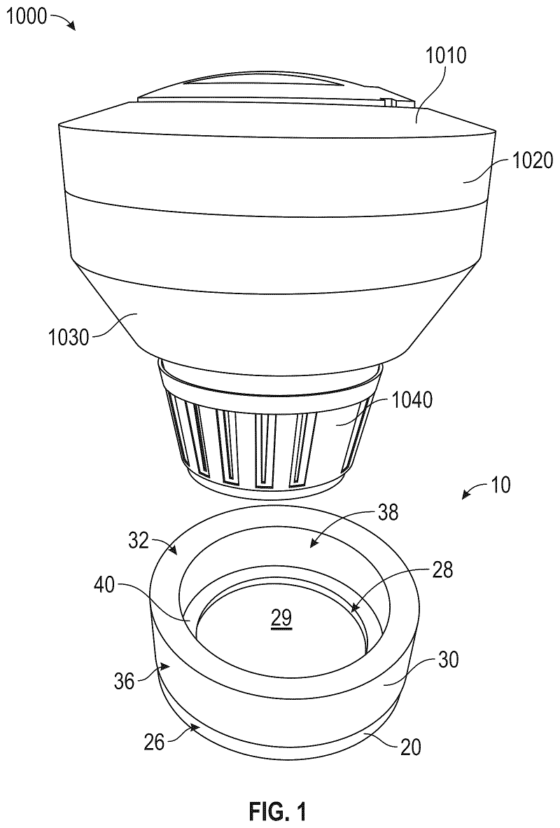

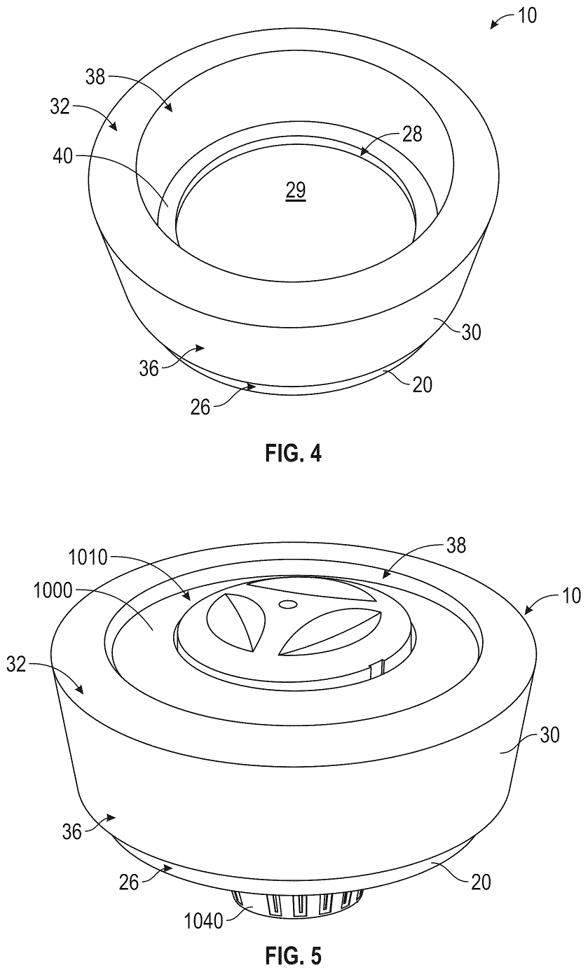

FIGS. 1-8 together disclose a debris removal sleeve 10 in accordance with at least one embodiment of the present invention. The debris removal sleeve 10 in its simplest form has a circular flange 20 and a cylindrical collar 30 coupled to the circular flange 20. The cylindrical collar 30 has a top surface 32 and a bottom surface 34. The circular flange 20 also has a top surface 22 and a bottom surface 24. The bottom surface 34 of the cylindrical collar 30 may be coupled to the top surface 22 of the circular flange 20. In an alternative embodiment, the bottom surface 34 of the cylindrical collar 30 may be integral with the top surface 22 of the circular flange 20; i.e. the debris removal sleeve 10 is only one piece and the cylindrical collar 30 extends upwardly and perpendicularly from the top surface 22 of the circular flange 20. The cylindrical collar 30 is positioned perpendicular to the circular flange 20. The debris removal sleeve 10 may be constructed of an open cell foam material such as, but not limited to reticulated polyester foam, reticulated polyurethane foam, any other suitable coarse oil-absorbing buoyant foam.

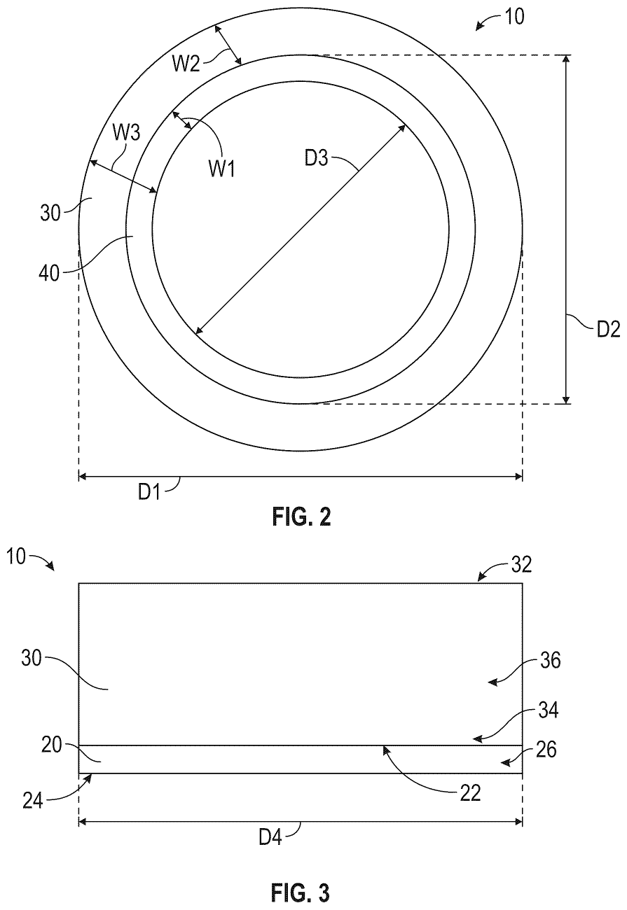

The debris removal sleeve 10 is configured to be used with multiple types of floating pool/spa chlorine dispensers: one type of standard floating pool/spa chlorine dispenser 1000 is shown in FIG. 1; and another type of standard floating pool/spa chlorine dispenser 2000 is shown in FIG. 7. While the present invention is described as dispensing chlorine, it should be clearly understood that the present invention may be used to dispense bromine or other suitable pool cleaning products. FIG. 1 shows a debris removal sleeve 10 that is configured to receive and hold a standard floating pool chlorine dispenser 1000 therein. Referring to FIG. 2, when the debris removal sleeve 10 is used with a standard floating pool chlorine dispenser 1000, the cylindrical collar 30 of the debris removal sleeve 10 may have an outer diameter D1 of about 9 inches (22.86 cm); the circular flange 20 may have an inner diameter D3 of 6.13 inches (15.57 cm); and the cylindrical collar 30 may have an inner diameter D2 of about 7 inches (17.78 cm). The cylindrical collar 30 may have a width W2 of about 1 inch (2.54 cm) and the circular flange 20 may have a width W3 of about 1.44 inch (3.66 cm). Because of the difference between the width W3 of the circular flange 20 and the width W2 of the cylindrical collar 30, an inner portion of the circular flange 20 remains uncovered by the cylindrical collar 30. This uncovered area creates an inner support ring 40 having a width W1 of about 0.44 inch (1.12 cm).

In one embodiment shown in FIG. 3, the outer diameter D4 of the circular flange 20 may be equal to the outer diameter D1 of the cylindrical collar 30, making the outer side wall 26 of circular flange 20 contiguous with the outer side wall 36 of the cylindrical collar 30. In another embodiment, the outer diameter D4 of the circular flange 20 may be slightly smaller than the outer diameter D1 of the cylindrical collar 30.

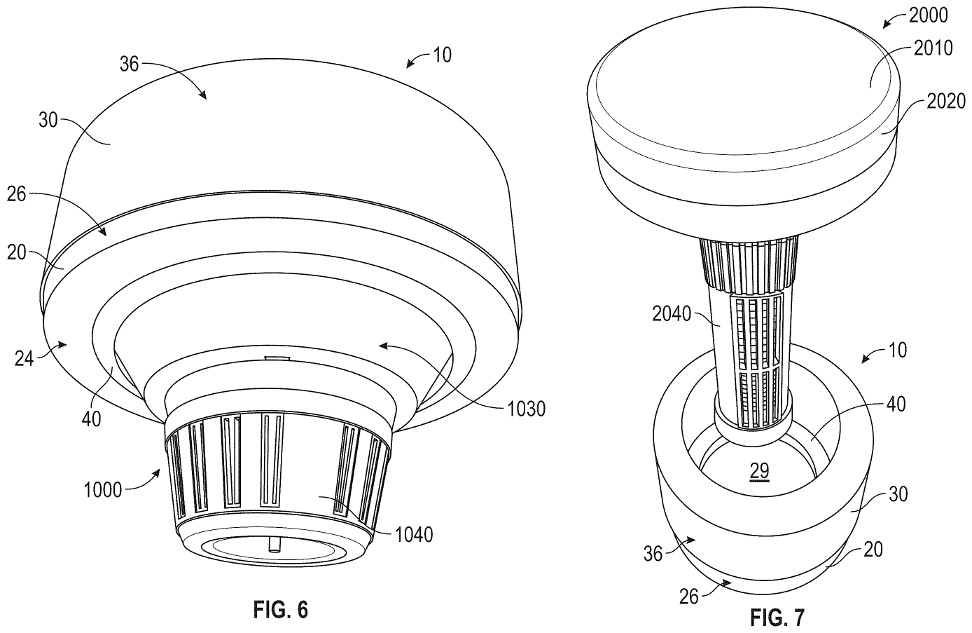

As shown in FIGS. 5-6, the standard pool chlorine dispenser 1000 is inserted into the debris removal sleeve 10. The standard pool chlorine dispenser 1000 is configured to fit snugly within the debris removal sleeve 10 with the side wall 1020 of the standard pool chlorine dispenser 1000 contacting the inner sidewall 38 of the cylindrical collar 30. The bottom dispensing end 1040 of the standard pool chlorine dispenser 1000 passes through the center aperture 29 of the debris removal sleeve 10. The center aperture 29 of the debris removal sleeve 10 is defined by the inner side wall 28 of the circular flange 20 and by the inner sidewall 38 of the cylindrical collar 30. The standard pool chlorine dispenser 1000 passes through the center aperture 29 of the debris removal sleeve 10 until the inner support ring 40 of the debris removal sleeve 10 contacts the tapered wall 1030 of the standard pool chlorine dispenser 1000, thereby holding the standard pool chlorine dispenser 1000 in place and preventing it from slipping downwardly through the debris removal sleeve 10. As also shown, the top end 1010 of the standard pool chlorine dispenser 1000 may sit lower than the top surface 32 of the cylindrical collar 30. It should be clearly understood that substantial benefit may still be obtained if the top end 1010 of the standard pool chlorine dispenser 1000 is level with the top surface 32 of the cylindrical collar 30. While the debris removal sleeve 10 is described above as having particular dimensions, it should be clearly understood that substantial benefit may still be derived if these dimensions of the debris removal sleeve 10 are proportionally increased or decreased to accommodate varying sizes of the floating pool/spa chlorine dispenser 1000.

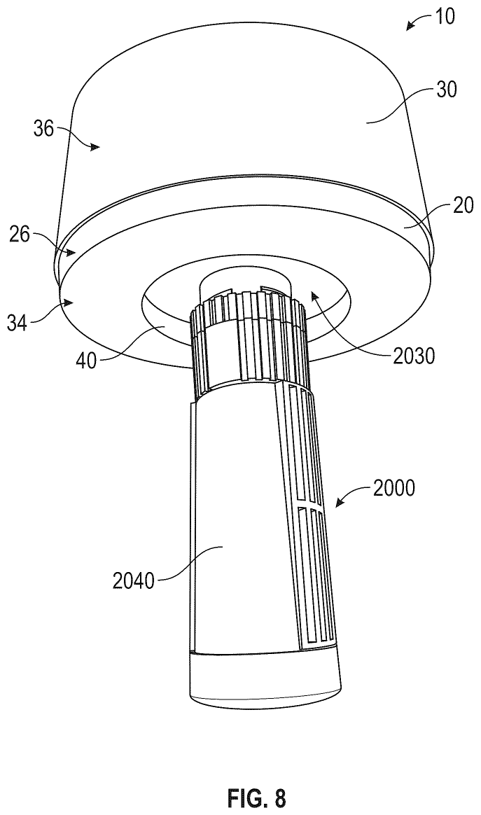

FIGS. 7-8 show a debris removal sleeve 10 that is configured to receive and hold a standard floating spa chlorine dispenser 2000 therein. When the debris removal sleeve 10 is used with a standard floating spa chlorine dispenser 2000, the cylindrical collar 30 of the debris removal sleeve 10 may have an outer diameter D1 of about 6.13 inches (15.57 cm); the circular flange 20 may have an inner diameter D3 of 3.5 inches (8.89 cm); and the cylindrical collar 30 may have an inner diameter D2 of about 4.5 inches (11.43 cm). The cylindrical collar 30 may have a width W2 of about 0.815 inch (2.07 cm) and the circular flange 20 may have a width W3 of about 1.315 inch (3.34 cm). Because of the difference between the width W3 of the circular flange 20 and the width W2 of the cylindrical collar 30, an inner portion of the circular flange 20 remains uncovered by the cylindrical collar 30. This uncovered area creates an inner support ring 40 having a width W1 of about 0.50 inch (1.27 cm).

As shown in FIG. 8, the standard spa chlorine dispenser 2000 is inserted into the debris removal sleeve 10. The standard spa chlorine dispenser 2000 is configured to fit snugly within the debris removal sleeve 10 with the side wall 2020 of the standard spa chlorine dispenser 2000 contacting the inner sidewall 38 of the cylindrical collar 30. The bottom dispensing end 2050 of the standard spa chlorine dispenser 2000 passes through the center aperture 29 that is defined by the inner side wall 28 of the circular flange 20. The standard spa chlorine dispenser 2000 passes through the center aperture 29 of the circular flange 20 until the inner support ring 40 of the debris removal sleeve 10 contacts the bottom wall 2040 of the standard spa chlorine dispenser 2000, thereby holding the standard spa chlorine dispenser 2000 in place and preventing it from slipping downwardly through the debris removal sleeve 10. The top end 2010 of the standard spa chlorine dispenser 2000 may sit lower than the top surface 32 of the cylindrical collar 30. It should be clearly understood that substantial benefit may still be obtained if the top end 2010 of the standard spa chlorine dispenser 2000 is level with the top surface 32 of the cylindrical collar 30.

When the debris removal sleeve 10 is coupled to the pool chlorine dispenser 1000 or the spa chlorine dispenser 2000, the debris removal sleeve 10 will float about the pool or spa. As it floats, it will absorb oils and other greasy residue floating on the surface of swimming pool and spa water. The debris removal sleeve 10 also wipes away oil and residue that may be stuck to the coping of the pool or spa. While the debris removal sleeve 10 is described above as having particular dimensions, it should be clearly understood that substantial benefit may still be derived if these dimensions of the debris removal sleeve 10 are proportionally increased or decreased to accommodate varying sizes of the floating pool/spa chlorine dispenser 2000.

The foregoing description is provided to enable any person skilled in the relevant art to practice the various embodiments described herein. Various modifications to these embodiments will be readily apparent to those skilled in the relevant art and generic principles defined herein may be applied to other embodiments. Thus, the claims are not intended to be limited to the embodiments shown and described herein, but are to be accorded the full scope consistent with the language of the claims, wherein reference to an element in the singular is not intended to mean “one and only one” unless specifically stated, but rather “one or more.” All structural and functional equivalents to the elements of the various embodiments described throughout this disclosure that are known or later come to be known to those of ordinary skill in the relevant art are expressly incorporated herein by reference and intended to be encompassed by the claims. Moreover, nothing disclosed herein is intended to be dedicated to the public regardless of whether such disclosure is explicitly recited in the claims.

What is claimed is:

1. A debris removal sleeve comprising:
a circular flange;
a cylindrical collar positioned perpendicularly to the circular flange;
a center aperture passing through the debris removal sleeve; and
an inner support ring for securing a chlorine dispenser within the debris removal sleeve.

2. The debris removal sleeve of claim 1, wherein a bottom surface of the cylindrical collar is coupled to a top surface of the circular flange.

3. The debris removal sleeve of claim 1, wherein the circular flange is integral with the cylindrical collar and the cylindrical collar extends upwardly and perpendicularly from the circular flange.

4. The debris removal sleeve of claim 1, wherein the center aperture is defined by an inner side wall of the circular flange and an inner sidewall of the cylindrical collar.

5. The debris removal sleeve of claim 1, wherein the debris removal sleeve is constructed of a buoyant oil-absorbing foam material.

6. The debris removal sleeve of claim 5, wherein the foam material is one of reticulated polyester foam and reticulated polyurethane foam.

7. The debris removal sleeve of claim 1, wherein the debris removal sleeve is configured to receive a standard floating pool chlorine dispenser therein.

8. The debris removal sleeve of claim 7, wherein the cylindrical collar has an outer diameter of 9 inches, an inner diameter of 7 inches, and a width of 1 inch.

9. The debris removal sleeve of claim 8, wherein the circular flange has an outer diameter of 9 inches, an inner diameter of 6.13 inches, and a width of 1.44 inches.

10. The debris removal sleeve of claim 9, wherein the inner support ring has a width of 0.44 inch.

11. The debris removal sleeve of claim 1, wherein the debris removal sleeve is configured to receive a standard floating spa chlorine dispenser therein.

12. The debris removal sleeve of claim 11, wherein the cylindrical collar has an outer diameter of 6.13 inches, an inner diameter of 4.5 inches, and a width of 0.815 inch.

13. The debris removal sleeve of claim 12, wherein the circular flange has an outer diameter of 6.13 inches, an inner diameter of 3.5 inches, and a width of 1.315 inch.

14. The debris removal sleeve of claim 13, wherein the inner support ring has a width of 0.5 inch.

15. A debris removal sleeve comprising:
a circular flange;
a cylindrical collar positioned perpendicularly to the circular flange;
a center aperture passing through the debris removal sleeve, the center aperture being defined by an inner side wall of the circular flange and an inner sidewall of the cylindrical collar; and
an inner support ring for securing a chlorine dispenser within the debris removal sleeve,
wherein the debris removal sleeve is constructed of a buoyant oil-absorbing open cell foam material.

16. The debris removal sleeve of claim 15, wherein the circular flange is integral with the cylindrical collar and the cylindrical collar extends upwardly and perpendicularly from the circular flange.

17. The debris removal sleeve of claim 15, wherein the debris removal sleeve is configured to receive a standard floating pool chlorine dispenser therein; wherein the cylindrical collar has an outer diameter of 9 inches, an inner diameter of 7 inches, and a width of 1 inch; wherein
the circular flange has an outer diameter of 9 inches, an inner diameter of 6.13 inches, and a width of 1.44 inches; and wherein the inner support ring has a width of 0.44 inch.

18. The debris removal sleeve of claim 15, wherein the debris removal sleeve is configured to receive a standard floating spa chlorine dispenser therein; wherein the cylindrical collar has an outer diameter of 6.13 inches, an inner diameter of 4.5 inches, and a width of 0.815 inch; wherein the circular flange has an outer diameter of 6.13 inches, an inner diameter of 3.5 inches, and a width of 1.315 inch; and wherein the inner support ring has a width of 0.5 inch.

19. A debris removal sleeve comprising:
a circular flange;
a cylindrical collar being integral with and extending upwardly and perpendicularly from the circular flange;
a center aperture passing through the debris removal sleeve, the center aperture being defined by an inner side wall of the circular flange and an inner sidewall of the cylindrical collar; and
an inner support ring for securing a chlorine dispenser within the debris removal sleeve,
wherein the debris removal sleeve is constructed of one of reticulated polyester foam and reticulated polyurethane foam.

20. The debris removal sleeve of claim 19, wherein the debris removal sleeve is configured to receive one of a standard pool chlorine dispenser and a standard spa chlorine dispenser therein.
